(19) United States
(12) Patent Application Publication
(10) Pub. No.: US 2007/0170677 A1
(43) Pub. Date: Jul. 26, 2007

(54) Spring

(76) Inventor: Bob Wake, Marina Del Rey, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/557,929

(22) Filed: Nov. 8, 2006

Related U.S. Application Data
(60) Provisional application No. 60/760,205, filed on Jan. 20, 2006.

(51) Int. Cl. B62M 1/00

(52) U.S. Cl. 280/87.042

(57) ABSTRACT

There is disclosed a sporting good, such as a skateboard, including a deck, a leaf spring and a set of wheels. The leaf spring is held fast to the deck via an attachment. Additionally, the leaf spring has a geometry that is axially concave. The set of wheels is held fast to the leaf spring via a binding. The leaf spring has a first width proximate the attachment and a second width proximate the binding, wherein the first width is wider than the second width.

### RELATED APPLICATION INFORMATION

This patent claims priority to U.S. Provisional Application No. 60/760,205, filed Jan. 20, 2006, which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to springs for sporting equipment.

2. Description of the Related Art

Skateboarding has been popular for more than forty years. Initially, skateboards had wooden boards and roller skate wheels. As skateboarding progressed, skate parks were created, skate competitions became prevalent and skateboard technology quickly advanced.

In particular, heritage skateboards consisted of a basic deck, wheels, trucks, bearings and bolts. Classically, a deck was an oak two by four; wheels were made of steel. Modernly, skateboards include stronger, more durable, even exotic materials, as well as the option to include one or more of the following components: rails, copers, lapers, nose guards, tail guards and risers.

Currently, approximately 12 million people take part in skateboarding. Many skaters negotiate tricks with ledges, benches, stairs, ramps, quarter pipes, half pipes and handrails. Among the popular tricks, the following types are the most common: aerials, freestyles, flip tricks, grabs, grinds, kickflips and slides.

Perhaps the most fundamental skateboard trick is the ollie, a trick dating back approximately thirty years. The basic ollie includes the following steps: (1) the skater begins with a horizontal stance, (2) the skater moves the front foot towards the center of the deck, (3) the skater pushes the tail of the deck down while jumping into the air, (4) as the curved tail strikes the ground, the skateboard lifts off the ground causing the nose to remain inclined relative the tail (5) the skater then slides their front foot forward and upwards, thereby lifting the skateboard further into the air, (6) while off the ground, the skater levels the skateboard, by pushing their front foot downwards near the nose of the skateboard, (7) finally, the skater lands with the skateboard in a horizontal position relative the ground.

Mastering the ollie is key to many skateboard tricks. In order to perform many advanced tricks, skaters must catch big air. In fact, it is not uncommon to gain over four feet vertically with the ollie, enabling a skater to clear large obstacles.

### DESCRIPTION OF THE DRAWINGS

FIG. 1 is a top perspective view of a skateboard.

FIG. 2 is a bottom plan view of the skateboard.

FIG. 3 is a bottom perspective view of the skateboard.

### DETAILED DESCRIPTION

Throughout this description, the embodiments and examples shown should be considered as exemplars, rather than limitations on the apparatus and methods disclosed or claimed.

Description of Apparatus

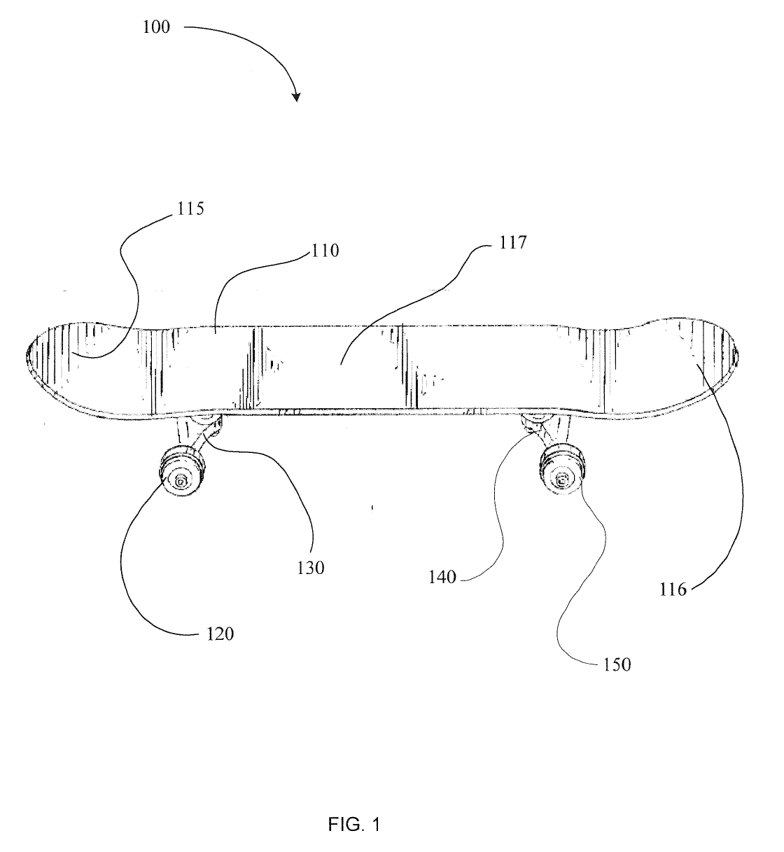

Referring now to FIG. 1, there is shown a top perspective view of a skateboard 100. The relative position of various parts of the skateboard 100 will be described based upon this view. For example, terms such as top, bottom, left and right are used. However, the skateboard 100 may be used in various positions such as upside down. Thus, some descriptive terms are used in relative terms and not absolute terms.

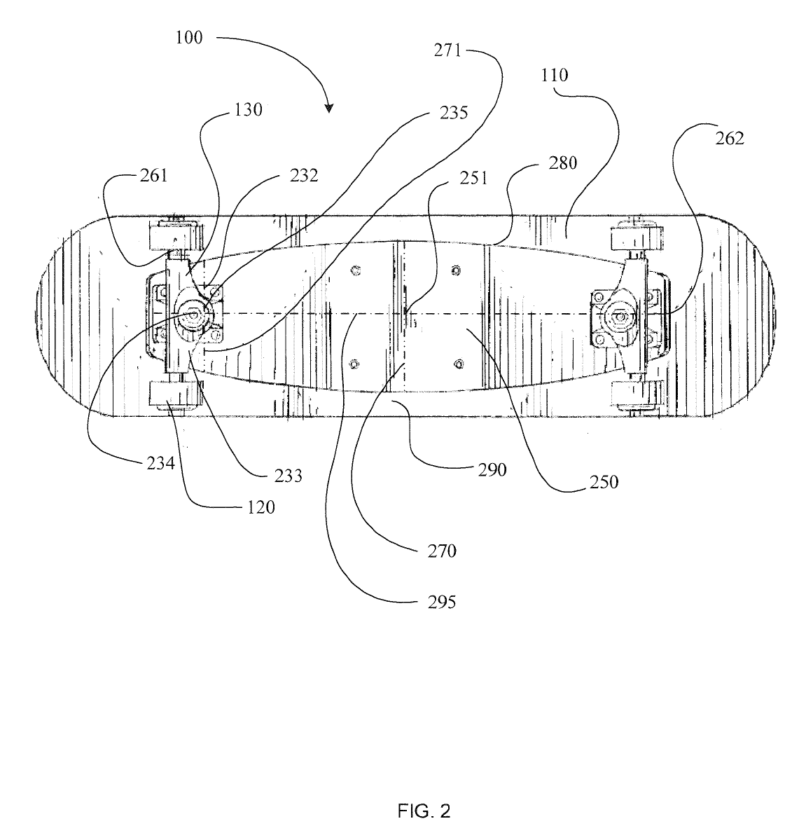

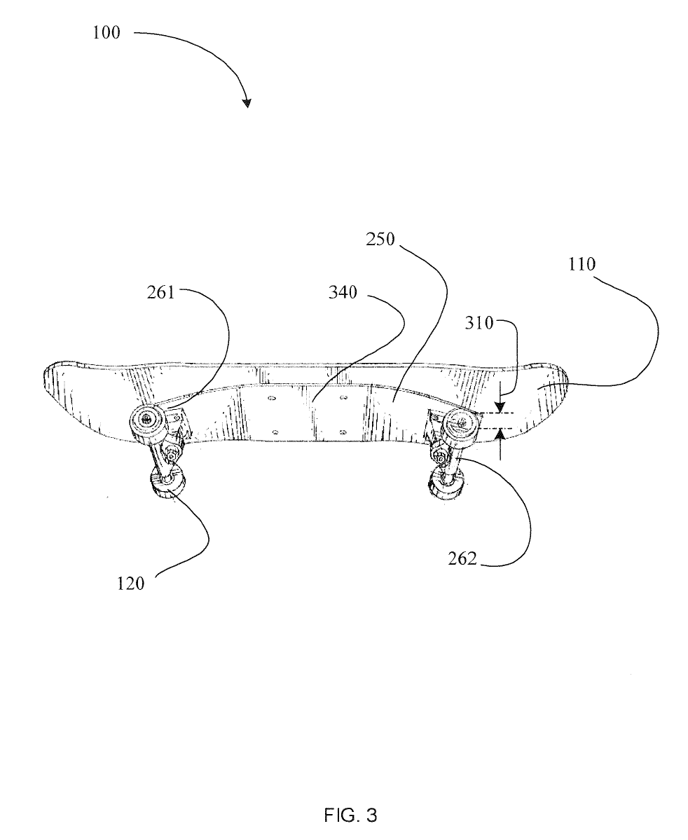

Fundamentally, the skateboard 100 includes a deck 110, two sets of wheels 120, 150 and two truck assemblies 130, 140. Although truck assemblies 130, 140 may connect respective sets of wheels 120, 150 directly to the deck 110, the skateboard 100 described herein includes a suspension 250, described with regard to FIG. 2 and FIG. 3, which secures the truck assemblies 130, 140 to the deck 110. The skateboard 100 defines a body 117 and ends 115, 116.

The deck 110 may be manufactured as a multiple layer laminate of wood veneers with adhesive resins. Sugar maple wood is a common material that may be used to form the deck 110 due to its mechanical properties and human feel. However, composite materials such as fiberglass, metal loaded polymers and other exotic materials may be substituted for or used in conjunction with wood.

The layers of wood laminate and resin may be pressed together utilizing heat and pressure; then cured, thereby forming a complex geometry. The geometry of the deck 110 may be concave with the first end 115 and second end 116 curving away from the generally axially flat body 117 of the deck 110. Subsequent to the curing of the laminate, the deck 110 may be refined via common machinery such as routers, lathes and mills.

Because the body 117 is axially flat, the deck 110 may be stood on and rode by a skater. Additionally, because the first end 115 and second end 116 are curved, the skater may press down, kick or jump the skateboard 100, thereby performing tricks. The specific geometry and dimensions of the deck 110 may be selected based on the height and weight of the skater as well as the maneuvers and conditions that the skateboard 100 will endure.

The two sets of wheels 120, 150 may be substantially identical, as may be the two truck assemblies 130, 140. The set of wheels 120, 150 may be formed of four circular frames of metal, wood, or other hard material. The wheels may be solid, partly solid, or spoked, and have a hub at the center for attachment to or suspension from an axle (not shown) on which they may revolve and bear a load. The specific design of the set of wheels 120, 150 may be based on the skating characteristics the skater desires.

The set of wheels 120, 150 may have a diameter from approximately 50 mm to approximately 100 mm. For instance, a set of wheels having a smaller diameter may allow for easier kickflips and ollies. Likewise, the skater may choose a set of wheels 120, 150 that are manufactured of a hard polyurethane or other material. For example, a set of wheels having a hard material tends not to absorb much energy during difficult tricks.

In contrast, the set of wheels 120, 150 may have a large diameter, tailored for speed. In hope of achieving increased speeds, a skater who enjoys slalom or downhill skating may choose a relatively large set of wheels. Furthermore, the set of wheels 120, 150 may include three, five or other number of wheels based on the turning characteristics, the desired rolling friction, the speed characteristics or the durability that the skater wishes to utilize.

Referring now to both FIG. 2 and FIG. 3, there is shown a bottom plan view and a bottom perspective view of the skateboard 100, respectively.

Each truck assembly 130, 140 may include an axle 231 to which two wheels 120, 150 are attached. Additionally, the truck assemblies 130, 140 may include a base plate 232, such as a flange, that is a surface adapted to mount to the suspension 250. Furthermore, the truck assemblies 130, 140 may include a hangar 233, which is a member through which the axle 231 passes. Finally, the truck assemblies 130, 140 may include a kingpin 234, which is a bolt or other fastener, which holds the hangar 233 in place.

The kingpin 234 may fit through the hangar 233 via a bushing 235 or other dampener. The bushing 235 may be selected based on the stiffness that the skater desires for given tricks, such as the ollie. Trick skaters tend to prefer a stiff bushing so that the bushing does not dissipate much mechanical energy. Moreover, the kingpin 234 may be adjusted relative the suspension 250 to increase or decrease the ability to roll the deck 110 relative the axle 231.

The truck assemblies 130, 140 may be attached to or held fast to the suspension 250 proximate the first end 261 of the suspension 250. Also, the suspension 250 may be secured to the deck 110 via an attachment proximate the mid-section 290 of the deck 110. To enumerate, attachments may include fasteners such as bolts or screws, adhesives such as glues, magnets and combinations therein. The attachments may be removable and/or adjustable.

In one embodiment (not shown), the suspension and the deck may be manufactured as a unitary device. More specifically, the suspension and the deck may be a single integral component that is molded and/or precision machined. The omission of fasteners and other hardware may allow for a stronger, more durable suspension and deck combination. Moreover, the cost to manufacture a unitary device omitting a fastening process may be less than a multi-step process.

To explain, the suspension 250 is a device which supports the deck 110 of the skateboard 100 on the truck assemblies 130, 140 or the set of wheels 120, 150. The suspension 250 may include or be a spring, a set of springs, a truss, or other assemblage of beams, rods, bars, brackets or other mechanical components. Although each truck assemblies 130, 140 may be mounted to a separate leaf spring, the suspension 250 of FIG. 2 and FIG. 3 is a single leaf spring.

The leaf springs shown may be made of spring steel. The leaf spring may be made of steel and/or other strong materials which exhibit spring characteristics such as deflection. For example, the leaf spring may be manufactured from aluminum, composite fibers, steel alloys or other materials. Spring steels, commonly, are high-carbon alloys, stainless steel, copper-based alloys, and nickel-based alloys.

Leaf springs may have the form of an arc-shaped length with a rectangular cross-section. Additionally, leaf springs may have a semi-elliptical, or other part elliptical axial shape. As shown in FIG. 3, the suspension 250 includes a geometry having an arc-shaped length wherein the suspension 250 is curved away from the deck 110.

In detail, the shape of the suspension 250, when the suspension means is not loaded, is referred herein as a free arch state. One example of when the skateboard 100 is in the free arch state is when a skater is not standing on the deck 110. In the free arch state, the suspension 250 retains its maximum radius of curvature. With this in mind, the set of wheels 120, 150 are disposed at a maximum distance 310 from the deck 110. In other words, the suspension 250 is axially curved or axially concave when unloaded or in a natural state relative the deck 110.

The suspension 250 stores mechanical energy when compressed, deformed or deflected. To illustrate, when a skater stands on the top of the deck 110, the suspension 250 may deflect such that the first end 261 and/or the second end 330 of the suspension 250 are closer to the deck 10 than when a skater is not standing on the deck 110. The amount of deflection may be based, in part, on the spring coefficient of the suspension 250 and the weight of the skater.

In order to both maximize the amount of mechanical energy that the suspension 250 can store, as well as provide a system wherein the skater can ride close to the ground, the suspension 250 may be adapted to have a compound arch height of approximately zero when the skater is riding on the skateboard 100. The term compound arch height refers to the perpendicular distance between an imaginary line connecting a first end 261 and a second end 330 of the suspension 250 through the center of the suspension 250.

Because skaters vary greatly in age, riding ability and weight, skateboards 100 may be manufactured with many different suspensions 250, each having a different spring rate. Thus, a heavier skater may select a skateboard 100 having a stiffer suspension 250 than a lighter skater. In this way, even a large skater may be able to achieve enhanced ollie performance.

Once mechanical energy is stored via spring deflection, a trick may be enhanced by removing at least a portion of the load from the deck 110. For example, when a person shifts their weight from the deck 110, jumps up from the deck 110, or ceases applying pushing force towards the deck 110, the load on the deck 110 decreases. In turn, the suspension 250 will return to its free arch state.

Consequently, when the suspension 250 returns to the free arch state, the compound arch height becomes greater than zero. In releasing the stored mechanical energy, the suspension 250 may apply a force towards the deck 10 and/or away from the truck assemblies 130, 140 of the skateboard 100. As a result, the skateboard 100 launches off the ground or other surface.

With this in mind, a novice skater may be able to learn the ollie with greater ease as the skateboard 100 tends to jump with the skater. Moreover, with the suspension 250 forcing the skateboard 100 into the air, the experienced skater may more easily accomplish extreme aerials.

As well as having a curved geometry when viewing the suspension 250 from a side perspective, the suspension 250 may include additional structural and geometric features that affect the ability to perform advanced tricks. For example, the suspension 250 may include a generally lengthwise axially symmetric geometry. For illustration purposes, the lengthwise axis is depicted with broken line 295. Additionally, the suspension 250 may include a mid section 251 having a first width 270, the first end 261 having a second width 271.

More specifically, the width of the suspension 250 may decrease from the axial center or mid section 251 of the suspension 250 towards either or both the first end 261 and the second end 262. Therefore, the second width 271 may be narrower than the first width 270.

The degree of decrease in width axially from the center of the suspension 250 towards the first end 261 of the suspension 250 may be selected based on the torsion stiffness which the skater desires. In turn, the long edge 280 of the suspension 250 may have a moderate curved geometry, a generally oval, circular, or curved geometry or stepped geometry relative the long edge 280 of the suspension 250.

As a result of the curved geometry of the long edge 280, the suspension 250 may be attached to the deck 10 with fasteners that are spaced apart relatively widely. In turn, the attachment of the suspension 250 to the deck 110 may be very strong and resist twisting. Furthermore, because the second width 271 is relatively narrow, as the skater leans the deck 110 either to the right or the left, it is unlikely that the suspension 250 will interfere with the set of wheels 120, 150.

Notwithstanding the application of the suspension 250 to a skateboard 100, the suspension 250 discussed herein may be applied to snowboards, inline skates, skis, and other sporting goods via bindings and the base of foot equipment rather than truck assemblies 130.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

For any means-plus-function limitations recited in the claims, the means are not intended to be limited to the means disclosed herein for performing the recited function, but are intended to cover in scope any means, known now or later developed, for performing the recited function.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A sporting good comprising:
a deck
a leaf spring held fast to the deck via an attachment, the leaf spring having an axially curved geometry in an unloaded state
two sets of wheels held fast at spaced locations to the leaf spring
the leaf spring having a first width and a second width, the first width proximate the attachment, the second width proximate an end of the leaf spring, the first width wider than the second width.

2. The sporting good of claim 1 wherein the axially curved geometry is an elliptical geometry.

3. The sporting good of claim 1, wherein the leaf spring is adapted to deflect to a compound arch height of approximately zero when loaded.

4. The sporting good of claim 1, wherein the leaf spring has a compound arch height of greater than approximately zero when the leaf spring is in a free arch state.

5. The sporting good of claim 1, wherein the leaf spring has a geometry having a width that generally decreases from the axial center of the leaf spring to the axial end of the leaf spring.

6. The sporting good of claim 1, wherein the leaf spring is adapted to apply a force towards the deck when a person removes their weight from the deck.

7. The sporting good of claim 1, wherein the leaf spring has a geometry having a width that generally decreases from the attachment towards the end.

8. An apparatus comprising:
a binding
a suspension means attached to the binding proximate an end of the suspension means, the suspension means adapted to be removably attached to a base
the suspension means having a first width and a second width, the first width proximate the end, the first width narrower than a width of the suspension means proximate a location where the suspension means is adapted to be removably attached to a base.

9. The apparatus of claim 8 wherein the suspension means has an axially curved geometry.

10. The apparatus of claim 8, wherein the suspension means is adapted to deflect to a compound arch height of approximately zero when a skater is standing on the deck.

11. The apparatus of claim 8, wherein the suspension means has a compound arch height of greater than approximately zero when the suspension means is in a free arch state.

12. The apparatus of claim 8, wherein the suspension means has a geometry having a width that generally decreases from the axial center of the suspension means to the axial end of the suspension means.

13. The apparatus of claim 8, wherein the suspension means is adapted to apply a force away from the binding when a person removes their weight from the suspension means.

14. A spring comprising:
a lengthwise axially curved geometry in an unloaded state, the lengthwise axially curved geometry having an end and a center
wherein the lengthwise axially curved geometry is adapted to deflect to a compound arch height of approximately zero when the load of a person is applied proximate the center and the end receives mechanical support
wherein the spring has a compound arch height of greater than approximately zero when the spring is in a free arch state
wherein the spring has a width that generally decreases from the center to the end.

15. The spring of claim 14, wherein the spring includes a leaf spring.

16. The spring of claim 14, wherein the axially curved geometry is a quarter elliptical geometry.

17. The spring of claim 14, wherein the spring includes a spring steel material.

18. The spring of claim 14 wherein a deck of a skateboard is attached proximate the center and a truck assembly is attached proximate the end.

19. A ski binding including the spring of claim 14.

20. A snowboard binding including the spring of claim 14.
